(19) United States
(12) Patent Application Publication
(10) Pub. No.: US 2012/0300073 A1
(43) Pub. Date: Nov. 29, 2012

(54) APPLICATION SERVER AND METHOD FOR FINDING PARKING SPACE

(75) Inventor: CHUN-AN LAI, Tu-Cheng (TW)

(73) Assignee: HON HAI PRECISION INDUSTRY CO., LTD., Tu-Cheng (TW)

(21) Appl. No.: 13/441,848

(22) Filed: Apr. 7, 2012

(30) Foreign Application Priority Data
May 23, 2011 (TW) 100117896

(51) Int. Cl. G08G 1/14; H04N 7/18

(52) U.S. Cl. 348/148; 348/E07.085

(57) ABSTRACT

An application server device and a method for finding parking space receives images of parking lots captured by cameras of the parking lot. The images are analyzed to obtain parking information of each of the parking lots. Location information of the parking lots, in which empty parking space exists, is sent to data receivers of cars, and location information of empty parking space of a parking lot is then sent to a data receiver of a car, when the car enters into the parking lot.

### BACKGROUND

1. Technical Field

Embodiments of the present disclosure relate to monitoring technology, and more particularly to an application server and a method for finding empty parking space for drivers.

2. Description of Related Art

In the downtown areas of most cities, finding an empty parking space can be a frustrating experience. In addition, drivers cruising for parking spots may generate a large percentage of all downtown congestion. Thus, a method that enables the drivers to find empty parking space in a timely manner is desired.

### BRIEF DESCRIPTION OF THE DRAWINGS

FIG. 1 is a block diagram of one embodiment of an environment architecture for finding parking space.

FIG. 2 is a block diagram of one embodiment of an application server in the environment architecture in FIG. 1.

FIG. 3 is a flowchart of one embodiment of a method for finding parking space.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

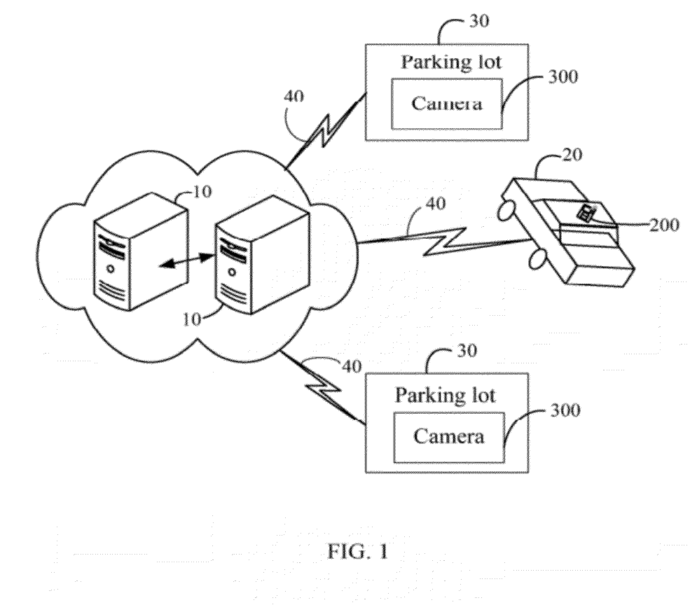

FIG. 1 is a block diagram of one embodiment of an environment architecture for finding parking parks. In the present embodiment, the environment architecture for finding parking space is composed of an application server 10, a plurality of cars 20 (only one car is shown), and a plurality of parking lots 30 (only two are shown).

The application server 10 in the present embodiment is a cloud server. The cloud server is a server dedicated to be used in a cloud computing environment. The cloud server differs from a regular server in part in that the resources on the cloud server, such as computing power and data storage space, can be used more efficiently. The cloud server can run any of a number of server operating systems.

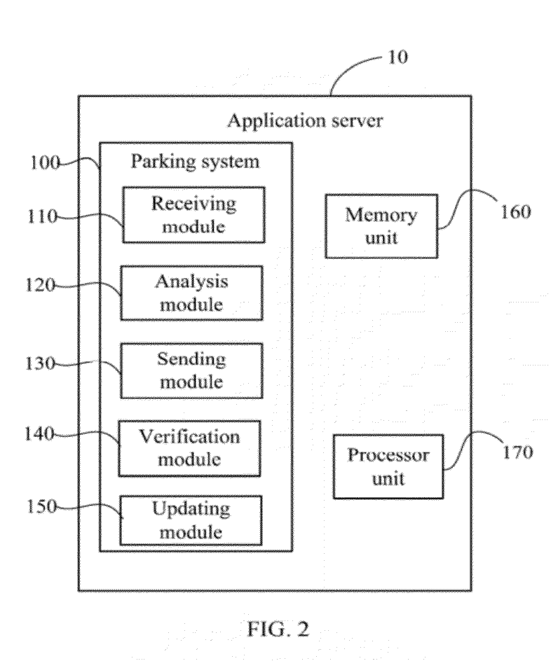

The application server 10 includes a parking system 100 composed of a plurality of function modules (see FIG. 2 below). The parking system 100 can obtain parking information of each of the parking lots 30 according to images of the parking lots 30, and sends location information of empty parking space to the cars 20. The parking information of a parking lot 30 may include a number and location of empty parking space in the parking lot 30.

Each of the parking lots 30 includes one or more cameras 300. The cameras 300 can capture panoramic images of the parking lot 30. The images are sent to the application server 10 via a wireless network 40.

Each of the cars 20 includes a data receiver 200, which can receive the location information of the empty parking space from the application server 10 via the wireless network 40.

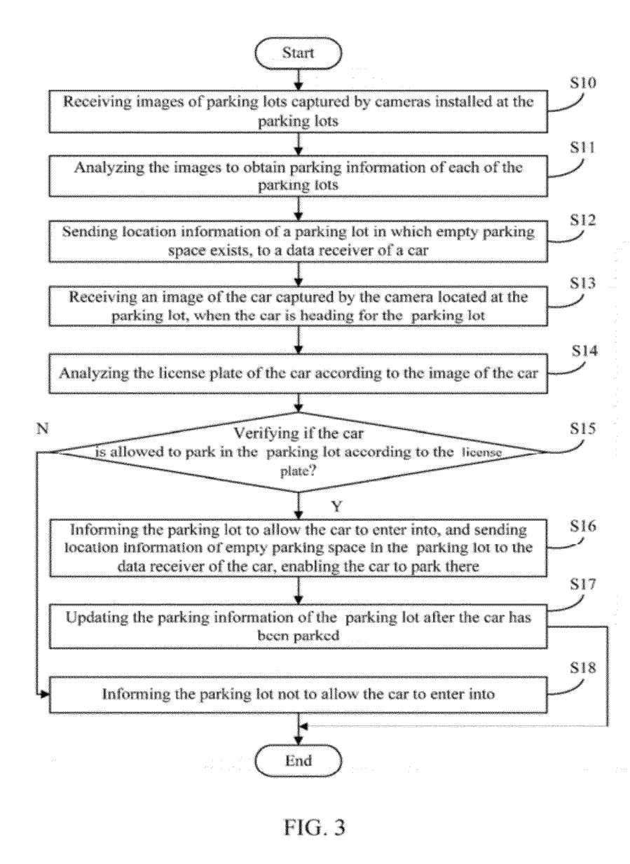

FIG. 2 is a block diagram of one embodiment of the application server 10. As mentioned above, the application server 10 includes the parking system 100 composed of a plurality of function modules. In one embodiment, the function modules may include a receiving module 110, an analysis module 120, a sending module 130, a verification module 140, and a updating module 150. The function modules 110-150 includes computerized code, when executed to realize functions of the parking system 100 as illustrated in FIG. 3.

The application server 10 further includes a memory unit 160. The memory unit 160 may include non-transitory computer-readable storage medium, such as a hard disk drive, a compact disc, a digital video disc, or a tape drive . The memory unit 160 stores the computerized code of the function modules of the parking system 100.

In addition, the application server 10 includes a processor unit 170. The processor unit 170 may include a processor, a microprocessor, an application-specific integrated circuit (ASIC), and a field programmable gate array (FPGA), for example. The processor unit 170 may execute the computerized code of the function modules of the parking system 100 to realize the functions of the parking system 100.

FIG. 3 is a flowchart of one embodiment of a method for finding parking space. Depending on the embodiment, additional steps may be added, others removed, and the ordering of the blocks may be changed.

In step S10, the receiving module 110 receives images of the parking lots 30 captured by the cameras 300 of the parking lots 30. In one embodiment, the location information of a parking lot 30 is affixed to the images of the parking lot 30 to be sent to the receiving module 110.

In step S11, the analysis module 120 analyzes the images of the parking lots 30 to obtain parking information of each of the parking lots 30. As mentioned, the parking information of a parking lot 30 includes a number and locations of empty parking space in the parking lot 30. The analysis module 120 may extract pixel values from the images, and compare the pixel values to obtain the parking information.

In step S12, the sending module 130 sends location information of the parking lots 30, in which empty parking space exists, to data receivers 200 of the cars 20.

In step S13, the receiving module 110 receives an image of a car 20 captured by a camera 300 of a parking lot 30, when the car 20 is heading for the parking lot 30 and reaching the capturing area of the camera 300 of the parking lot 30. It may be understood that, the capturing area of the camera 300 means the area where the camera 300 can “see” the car 20.

In step S14, the analysis module 120 analyzes the image of the car 20 to obtain the license plate of the car 20. Similar to above, the analysis module 120 extracts pixel values from the image of the car 20, and obtains the license plate of the car 20 according to the pixel values.

In step 15, the verification module 140 determines if the license plate is associated with the parking lot 30, namely if the car 20 is allowed to park in the parking lot 30. In one embodiment, the memory unit 160 may store a plurality of lists, each of which records a parking lot 30 and one or more associated license plates. If the license plate of the car 20 and the parking lot 30 are recorded in the same list, the license plate is associated with the parking lot 30, and the verification module 140 determines that the car 20 is allowed to park in the parking lot 30, then, step S16 is implemented. Otherwise, if the license plate of the car 20 and the parking lot 30 are not recorded in the same list, the license plate is not associated with the parking lot 30, and the verification module 140 determines that the car 20 is forbidden to park in the parking lot 30, then, step S18 is implemented.

In other embodiment, if parking lot 30 is a public parking lot, then there is no list relating the parking lot 30 in the memory unit 160. Thus, the verification module 140 determines that the license plate is associated with the parking lot 30 when there is no list relating the parking lot 30 in the memory unit 160.

In step S18, the verification module 140 informs the parking lot 30 to not allow the car 20 to park.

In step S16, the verification module 140 informs the parking lot 30 to allow the car 20 to enter the parking lot 30, and the sending module 130 sends location information of empty parking space to the data receiver 200 of the car 20, enabling the car 20 to park in the empty parking space.

In step S17, the updating module 150 updates the parking information of the parking lot 30 after the car 20 has been parked.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for finding parking space being performed by execution of computerized code by a processor of an application server, comprising:
receiving images of parking lots captured by cameras of the parking lots;
analyzing the images to obtain parking information of each of the parking lots;
sending location information of the parking lots, in which empty parking space exists, to data receivers of cars; and
sending location information of empty parking space of a parking lot to a data receiver of a car, when the car enters into the parking lot.

2. The method according to claim 1, wherein the location information of the parking lots are affixed to the images of the parking lots.

3. The method according to claim 1, wherein the parking information comprises a number and locations of empty parking space in a parking lot.

4. The method according to claim 1, wherein the parking information is obtained by extracting pixel values from the images.

5. The method according to claim 1, the method further comprising:
receiving an image of the car captured by the camera of the parking lot, when the car is heading for the parking lot and reaching the capturing area of the camera of the parking lot;
analyzing the image of the car to obtain the license plate of the car;
informing the parking lot not to allow the car to entry into the parking lot when the license plate does not associate with the parking lot; and
informing the parking lot to allow the car to enter into the parking lot when the license plate associates with the parking lot.

6. The method according to claim 1, wherein the application server is a cloud server.

7. An application server, comprising:
a non-transitory storage medium;
at least one processing unit; and
one or more modules that are stored in the non-transitory storage medium; and are executed by the at least one processing unit, the one or more modules comprising instructions to:
receive images of parking lots captured by cameras of the parking lots;
analyze the images to obtain parking information of each of the parking lots;
send location information of the parking lots, in which empty parking space exists, to data receivers of cars; and
send location information of empty parking space of a parking lot to a data receiver of a car, when the car enters into the parking lot.

8. The application server according to claim 7, wherein the location information of the parking lots are affixed to the images of the parking lots.

9. The application server according to claim 7, wherein the parking information comprises a number and locations of empty parking space in a parking lot.

10. The application server according to claim 7, wherein the parking information is obtained by extracting pixel values from the images.

11. The application server according to claim 7, wherein the one or more modules further comprise instructions to:
receive an image of the car captured by the camera of the parking lot, when the car is heading for the parking lot and reaching the capturing area of the camera of the parking lot;
analyze the image of the car to obtain the license plate of the car;
inform the parking lot not to allow the car to entry into the parking lot when <<See my edits above>> the license plate does not associate with the parking lot; and
inform the parking lot to allow the car to enter into the parking lot when the license plate associates with the parking lot.

12. The application server according to claim 7, wherein the application server is a cloud server.

13. A non-transitory storage medium having stored thereon instructions that, when executed by a processor of an application server, causes the processor to perform a method for finding parking space, wherein the method comprises:
receiving images of parking lots captured by cameras of the parking lots;
analyzing the images to obtain parking information of each of the parking lots;
sending location information of the parking lots, in which empty parking space exists, to data receivers of cars; and
sending location information of empty parking space of a parking lot to a data receiver of a car, when the car enters into the parking lot.

14. The storage medium according to claim 13, wherein the location information of the parking lots are affixed to the images of the parking lots.

15. The storage medium according to claim 13, wherein the parking information comprises a number and locations of empty parking space in a parking lot.

16. The storage medium according to claim 13, wherein the parking information is obtained by extracting pixel values from the images.

17. The storage medium according to claim 13, wherein the method further comprises:
receiving an image of the car captured by the camera of the parking lot, when the car is heading for the parking lot and reaching the capturing area of the camera of the parking lot;
analyzing the image of the car to obtain the license plate of the car;
informing the parking lot not to allow the car to entry into the parking lot when the license plate does not associate with the parking lot; and
informing the parking lot to allow the car to enter into the parking lot when the license plate associates with the parking lot.

18. The storage medium according to claim 13, the application server is a cloud server.
